(19) United States
(12) Patent Application Publication
(10) Pub. No.: US 2017/0021476 A1
(43) Pub. Date: Jan. 26, 2017

(54) FOLDABLE & EXTENDABLE 1/4 & 3/8 DRIVE RATCHET WRENCH

(71) Applicant: Thomas Carnesi, Torrance, CA (US)

(72) Inventor: Thomas Carnesi, Torrance, CA (US)

(21) Appl. No.: 15/074,674

(22) Filed: Jun. 27, 2016

(51) Int. Cl. B25B 13/48; B25G 1/06; B25G 1/04; B25B 13/46; B25B 23/00

(52) U.S. Cl. CPC B25B 13/481; B25B 13/463; B25B 23/0028; B25G 1/043; B25G 1/063

(57) ABSTRACT

A foldable and retractable ratchet wrench comprised of a ¼ inch driver end that manually folds down when not in use; a ⅜ inch fixed driver end; a ratchet arm that folds and locks to various angular positions; an exterior, knurled handle that pivotally folds outward and a cylindrical hollow tube embodiment that extends and retracts from the solid arm. The ¼ inch square driver end is housed within a horizontal square slot provided at an extending shank portion of the ratcheting gear. The ¼ inch square driver end swivels up substantially at right angle from the plane of the ratcheting head. The ratchet wrench's outer pivoted handle folds outward and is pivoted by a pivotal pin substantially at right angle. The slideable sub-tube arm is guided by a pin that rides along a longitudinal slot of said slideable sub-tube arm for various torque needs and is secured by a spring induced detent ball that seats vertically within the solid arm. The entire ratcheting arm swivels from a substantial at right angle to varied angles for ease in limited working spaces.

### BACKGROUND OF THE INVENTION

This utility provisional patent application is for a ratchet wrench having a fixed ⅜ inch driver end and a folding ¼ driver on the opposite end to adapt to both ¼ and ⅜ inch drive sockets for hex head fasteners, and a flexible and retractable handle having a plurality of leverage that flexes to various angles for torque requirements and ease of use in limited working spaces.

### CLASS 81/177 REFERENCES CITED

### U.S. Patent Documents:

| | | | |
|---|---|---|---|
| 1,018,080 | February, 1912 | Reston | 81/60. |
| 1,371,350 | March, 1921 | Campbell | |
| 1,578,065 | March, 1926 | Bemus et al. | |
| 1,626,906 | May, 1927 | Zilliox | |
| 1,769,070 | July 1930 | Nowosielski | |
| 2,636,411 | April, 1953 | Wood | 81/60. |
| 2,757,564 | August 1956 | Reaves | 81/61. |
| 2,897,437 | July 1959 | Briggs et al. | |
| 2,982,160 | May 1961 | Little | |
| 3,039,340 | June 1962 | Livermont | |
| 3,505,714 | April, 1970 | Boileau | |
| 3,572,188 | March, 1971 | Christian, Jr. | |
| 4,278,314 | July 1981 | Taub | |
| 4,324,158 | April, 1982 | Le Roy | |
| 4,441,387 | April, 1984 | Hsidericks | 81/61. |
| 4,480,511 | November, 1984 | Nickipuck | |
| 4,703,636 | November, 1987 | Mayer | 81/60. |
| 4,748,874 | June 1988 | Sharp et al. | |
| 4,768,405 | September, 1988 | Nickipuck | |
| 4,791,837 | December, 1988 | Main | |
| 4,825,732 | May 1989 | Arnold | |
| 4,905,549 | March, 1990 | Nickipuck | |
| 4,938,107 | July 1990 | Nickipuck | |
| 5,005,448 | April, 1991 | Main | 81/63. |
| 5,289,745 | March, 1994 | Beardsley | |
| 5,291,809 | March, 1994 | Fox, III et al. | |
| 5,901,620 | May 1999 | Arnold | 81/60. |
| 6,009,777 | January, 2000 | Jarvis | |
| 6,263,766 | July, 2001 | Jarvis | 81/60. |
| 6,516,689 | February, 2003 | Bates | 81/60. |

### SUMMARY OF THE INVENTION

1. The object of this invention is to provide a foldable ratchet wrench having a combined ¼ inch and a ⅜ inch universal driver on opposite sides of the ratcheting head for wrenching either a ¼ inch or ⅜ inch standard drive sockets. The ratchet wrench also includes a slide-able handle that extends outward to a plurality of lengths for required torque needs. The handle also flexes to a plurality of angular degrees from the plane of the axis for hard to access working spaces. This invention has several features that include but are not limited to: convenience of use, compactness when stored, with the extendable handle fully foldable, and a ¼ inch driver housed within a horizontal square slot provide at the extended cylindrical shank portion of the ratcheting gear. On the opposite end is a fixed ⅜ inch square driver attached onto the ratcheting gear at substantially at right angle. The ¼ and ⅜ inch square driver combination eliminates the need for two individual size ratchet wrenches. As the larger ⅜ inch fixed driver is being used, the ¼ inch, swivel, driver end can either be in a folded down position or swung upwards to substantially right angle for use.

2. The ratchet wrench further includes an outer handle that flexes pivotally to maximum of −180 degrees from the longitudinal axis plane when the need to flex said handle when higher torque needs are required. Each flexible setting of the sub-extendable tubular handle is secured by spherical dimples longitudinally located on the surface tubular surface; the solid handle portion of the extendable handle assembly further includes a yoke at the inner distal end that houses a spring induced detent ball that seats into each of the said spherical dimples that are spherically spaced at that ratchet head node and are at an approximate incremental 30 degrees spacing to adjust the handle flexibility when the need to work in cumbersome spaces, the coaxial pin retains and secures said handle assembly to said ratchet head assembly of embodiment 32.

3. The ratcheting gear further includes a fixed square shaft at substantially right angle to the ratcheting gear, and features an extended lower cylindrical shank that includes a horizontal square slot to accept a ¼ square driver end that is centrally pivoted that swivels inward and outward from a horizontal position to substantially at right angle working mode. The ¼ driver is fitted with a horizontal, press fitted, retaining pin. A ratcheting pawl, pivoting pin, detent ball, detent ball tension spring, exterior thumb-pawl lever, ratchet housing assembly cover and snap-ring for retaining the ratchet components. The ratchet gear of the present invention seats and rotates in a clockwise or counterclockwise reciprocal motion within the counter bore diameter of the ratchet head at the axis.

4. The pawl nestles within the ratchet head pocket at the aft portion of the ratcheting head. The pawl's exterior lever thumb piece is of a reciprocal lever type and can be either clicked in a forward or reverse direction that pivots on a vertical pawl pivot shaft, part of the ratcheting pawl integral body. Said ratcheting pawl is vertically located and aligned coaxially between the lower pocket wall of the ratchet head and the top cover plate. The ratchet pawl locks the ratcheting gear in either a clockwise or a counterclockwise direction (tightening or loosening of fasteners) the ratcheting gear is locked in. This function is accomplished with the aid of a spring induced detent ball located at the aft area of the ratchet head pocket and forward of the extending arm. The extending solid arm located from a distal end of said ratcheting head includes a vertical hole that seats a tension spring, and a detent spherical ball which seats within any of the three equally spaced holes on the top side of said exterior handle to secure said exterior handle to either the first and second positions for various torque requirements. Said exterior, hollowed tubular sub-handle, slides onto the solid arm feature at a distal from said ratcheting head thereof, and is secured by a vertical retention pin that rides along and within a horizontal slotted channel. Said channel extends longitudinally and is parallel to and located on the top side of said solid arm feature thus allowing the retention pin to permanently retain the exterior, and slide-able handle to said solid arm to either be extended away from the first length to second and or third length at distal from said ratchet head.

### BRIEF DESCRIPTION OF THE DRAWINGS

The preferred embodiment of this invention, illustrating all of its features, will now be discussed in detail. This embodiment depicts the novel and non-obvious extendable and angularly flexible ratchet wrench of this invention as shown in the accompanying drawings, which are for illustrative purposes only. The drawings include the following figures (FIGS.), with like numerals indicating like parts that are circled encased and lower case letters following numerals indicating related features on the numeric components such as teeth, pockets, holes, slots, grooves and/or channels:

FIG. 1 is a side view of the ratchet wrench embodiment in fully retracted mode.

FIG. 2 is a top-plan view of the ratchet wrench embodiment showing the fixed ⅜ inch in a fully retracted mode.

FIG. 3 is a bottom view of the ratchet wrench embodiment showing the foldable ¼ driver end in a fully retracted mode.

FIG. 4 is a top-plan view of the ratchet wrench embodiment showing the fixed ⅜ inch driver side with the knurl shell handle swiveled to 180 degrees extension.

FIG. 5 is side view of the ratchet wrench embodiment with the knurl shell handle swiveled to 180 degrees extension.

FIG. 6 is a side view of the ratchet embodiment in a fully extended mode.

FIG. 7 is a top view of the ratchet embodiment showing the ⅜ fixed drive end in a fully extended mode.

FIG. 8 is a bottom view of the ratchet embodiment in a fully extended mode.

FIG. 9 is an isometric view of the ratchet fully assembled with the ¼ driver end retracted.

FIG. 10 is a flexed and extended mode in a plan side view of the ratchet wrench embodiment.

FIG. 11 is an isometric view of the ratchet wrench embodiment in a flexed and extended mode.

FIG. 12 is an exploded isometric view of the ratchet embodiment.

FIG. 13 is an enlarged top view of the ratchet wrench head showing the fixed ⅜ driver end and ratcheting gear and pawl.

FIG. 14 is an enlarged bottom view showing the ¼ retractable driver end folded down.

FIG. 15 is an enlarged bottom view of the ratchet wrench head embodiment with the ¼ driver end at an extended working mode.

### A DETAILED DESCRIPTION OF THE PREFERRED EMBODIMENT

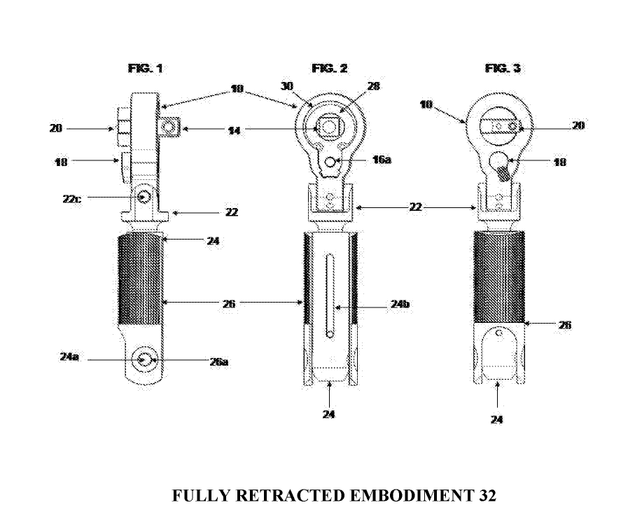

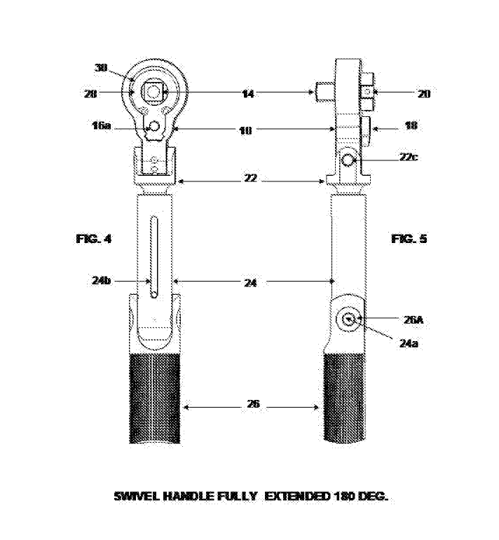

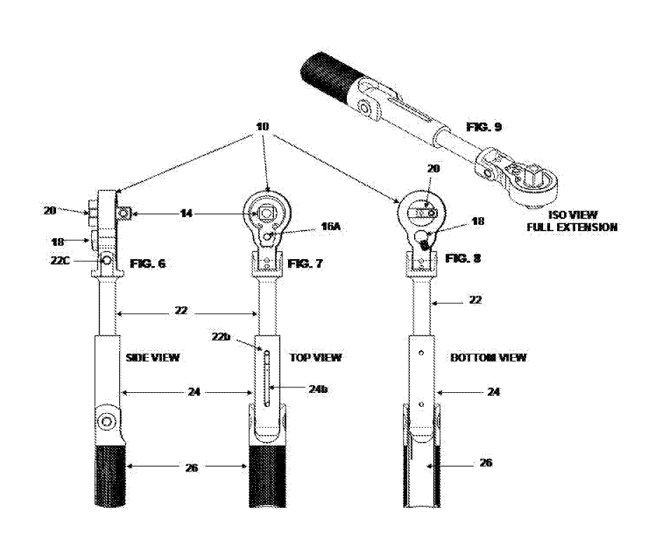

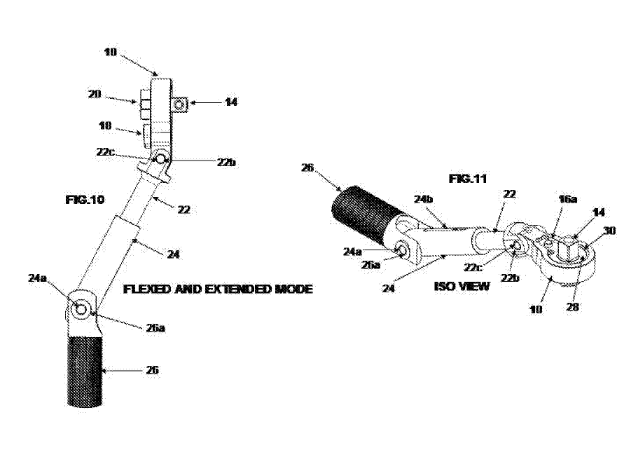

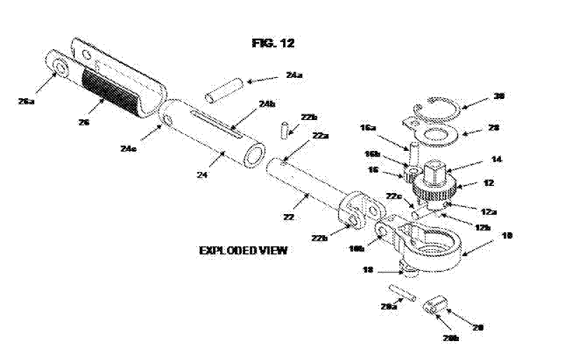

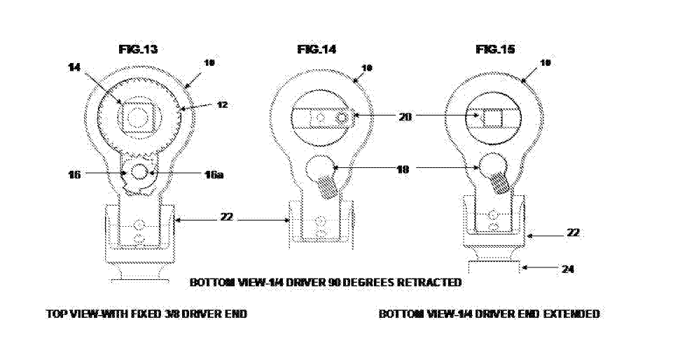

As best shown in FIGS. 1, 2, 3, 4, 5, 6, 7, 8, 9, 10, 11, 12, 13, 14, & 15 that are relevant to the design and function of this ¼ and ⅜ inch drive foldable ratchet 32 of this invention which includes: a ratchet head 10 with a solid swivel arm 22 substantially at right angle to the axis, said serrated ratcheting driver gear 12 being rotate-able about the axis includes serrated teeth 12a with a ⅜ inch square output shaft 14; said ⅜ square shaft further includes a detent ball 14a to retain sockets of the first end, said ratcheting driver gear 12 seats within the said ratchet head pocket 10a of said ratchet head 10 which is retained by an assembly cover 28; said assembly cover 28 corresponds to the peripheral configuration of said ratchet head pocket 10a of said ratchet head 10. The retaining snap-ring 38 is housed within said pocket 10b of said ratchet head 10 to retain the following ratcheting components: 12/12a/12b, 14, 14b, 20, 28 and 30. Said ratcheting driver gear 12a escapes in a rotate-able direction that is controlled by the reciprocal manual pivot lever 18, which is connected to the pawl pivot shaft 16 of said pawl 18, in either a forward or reverse reciprocal direction. When the user clicks the exterior pivotal arm of said pawl reciprocal lever 18 to its left, said driver gear teeth 12a of said ratcheting gear 12a escapes by ratcheting in a clockwise rotation. This rotation mode thus allows socket-to-fastener tightening and or loosening in that direction. When the user clicks said pawl 18 shaft said of pawl 18 to its right, this causes the driver gear 12a to escape ratchet in a counterclockwise rotation and this locks the gear teeth 12a of gear 12 for loosening and or tightening mode for fasteners in this direction. Said ratchet driver serrated teeth 12a of gear 12 can be locked in either direction, permitting escape rotation, via said ratcheting pawl 18 in one direction to either loosen or tighten operations, depending on the right or left reciprocal engagement of pawl teeth 18a or 18b, via said pawl lever 18, to either pivot forward (to the right) or reverse (to the left). When said reciprocating pawl 18 is clicked in either forward or reverse direction, the tension from spring bias 18c causes pressure on the detent ball 18d to seat into either cam pocket 18d or 28f to secure said pawl 18 in either the reverse or forward escape direction. Pawl 128a shaft of said pawl 18 is substantially right angle and pivots coaxially between hole 10f of said ratchet head 10 and said ratchet 18b vertical hole of said assembly cover 28, said pawl lever 18 is horizontally located on the underside of said ratchet head 10 and aft of the ¼ driver plug 16. The two serrated teeth 18a and 18b of said pawl 18 are spaced, at an approximate 45 degrees, diametrically apart and interlock with the serrated teeth 12a of said ratchet gear 12 in one direction at an approximate 22.50 degrees in either ratcheting direction. Said ratcheting teeth 18a and 18b are radially aligned with that of the cam pockets 18c and 18d of said pawl 18. Said ratcheting pawl 18 pivots to reciprocity at approximate 22.5 degrees, in either direction and vertically within said pocket 10c of said ratcheting head 10 of said ratchet embodiment 32. Said detent ball 18d, via tension induced spring 18c within either of the pawl pockets 18c and 18d of said pawl 18, said tension spring 18 and said detent ball 24 are housed in a horizontal hole 10f. Said retention hole 10e is angled approximately 180 degrees to that of the axis plane of said ratchet arm 22 of ratchet embodiment 32. Said ¼ inch square driver end 16 is pivotal to either a horizontal or substantially at right angle to the longitudinal axis working position. Said ratchet head 10, pocket 10a is concentric within said ratchet head 10 which houses said ratcheting gear 12. The smaller diameter counter-bore 10d is also concentric with that of counter bore 10a of ratchet head 10, thus allowing access for the extending driver shank 12b to house said ¼ square driver 16, said ¼ inch square driver pivots within horizontal slot 12c of shank 12b. The ⅜ inch fixed square driver plug 14, and said ratcheting gear 12 further includes a concentric diameter shank 14b that extends horizontally upward to the thickness of cover plate 28 within said ratchet head pocket 10a of said ratchet head 10, said shank diameter 14b rotates within hole 10b of said ratchet head 10. Said ratcheting head 10 further includes an extending lug 10g with a full radius end 10h, and a horizontally concentric hole 10j being coaxially aligned with a horizontal holes 22b formed on the ears of yoke 22a to house a horizontal retention pin 12b to attach and pivot said solid arm 22, via said yoke end attachment 22a coaxial holes to 10b coaxial lug holes to the square channel feature 22d of said yoke 22c. Said extending lug 10g further includes three spherical dimples 10k spaced 30 degrees radially to capture and retain detent ball 10d, via spring bias 22e, housed with a vertical hole 22f within a formed channel 22g of said yoke feature 22h being attached onto said solid arm 22, said solid arm 22 within said tubular extendable are 24 and said pivotal able exterior handle 26 can either be pivotally folded outward 180 degrees or folded back −180 to a compact stowage position connected by said pivotal pin 24a; said extendable handle 22 further includes a hollow slideable tube 24 which slides onto said solid arm 22 of ratchet embodiment 32; a vertical hole 22b at its underside for various length adjustments, a retention pin 22c with 22d to retain said extendable sub-tubular handle 24 via 24d and 24e adjusting spherical holes within the longitudinal axis of said solid arm 22. Said retention spring pin 22c is press fitted into said vertical hole 22d of said flexible handle 22 which is pivotally retained within 22b coaxial holes within 10f ratchet head lug embodiment retained by 22c pivot pin of the ratchet embodiment 32. Said retention spring pin 22c rides within said channel 24c located on the underside and parallel to the longitudinal axis of said solid arm 22. Said longitudinal channel 24b is approximately 3.00 inches in length, said channel 24b length reflects the maximum longitudinal distance of said slideable handle 24 and foldable handle 26 may extend. Said flexible ratchet arm 22 at a distal end of the ratchet head 10 of said ratchet embodiment 32 comprises: a vertical hole 22f to a depth to allow seating of said tension spring 22g on said detent ball 22h; said extendable sub-handle 24 includes two vertical exterior holes 24d, 24e, as said slide-able handle embodiment 24 is being extended along the longitudinal axis plane of the solid arm 22, the tension from said spring bias 22b induced upward on said detent ball 22c nestled within said hole 22d of said solid arm 22 catches and seats either into said vertical holes 24b and or 24c depending on the adjusted length the user may extend said sub-tubular handle 24 embodiment to.

### SCOPE OF THE INVENTION

The above represents the best descriptive mode contemplated in carrying out this invention, the manner and process of its manufacture, its utilization in such full, clear and concise terms as to enable any person skilled in the art to which it pertains to effectively produce and use this invention. This invention is, however, susceptible to modifications and alternate constructions thereof from that discussed above which are fully equivalent. Consequently, it is not the intention to limit this invention to the particular embodiment disclosed. On the contrary, the intent is to cover all modifications and alternate constructions coming within the spirit and scope of the invention as generally expressed by the following claims, which particularly point out and distinctly claim the subject matter of this invention.

I claim:

1. What is claimed is a ratcheting driver comprising a solid handle having a ratchet head at a distal end thereof; said solid handle having a slide-able hollowed exterior handle means being adjustable between first, second position; a ratcheting pawl mounted within said ratchet head to ratchet a serrated rotate-able gear mounted within said ratcheting head, said ratcheting gear further includes a square shaft at first end substantially at right angle to said ratcheting gear; said ratcheting gear further includes an extended cylindrical configured shank adapted to house a square second output shaft at 180 degrees thereof; a first output square shaft secured at a first end of said ratchet gear seated within said ratcheting head, said first output square shaft being sized to be received by a first socket adaptive to drive a hex configured fastener of a first size range;
and, a second output square shaft secured to said extended cylindrical shank of said ratcheting gear housed within said ratcheting head; said second output shaft being adaptive to drive a socket being adaptive to fit and drive a hex head fastener of a second size range, said second square output shaft being positioned substantially at right angle from the Y axis plane of said solid handle at a distal end of said ratchet head thereof;
wherein said ratchet driver is in a second mode of operation, said second square shaft being positioned substantially at right angle from said Y axis plane of said ratchet head when said ratchet driver is in a second mode of operation.

2. The driver of claim 1 wherein said handle is adjusted to said first position where said second output square shaft drives said socket of a second size range.

3. The driver in claim 1 wherein said handle is adjusted at said second position when said first or second output shafts drive said socket of either a first or second size range.

4. The device in claim 1 wherein said handle is adjusted at said third position when said second output shaft drives either said socket of a first or second size.

5. The device in claim 1 further includes a slotted channel extending longitudinally on the underside of said solid arm at a distal end thereof from said ratcheting head to retain said hollowed exterior handle at said first, second and third extended positions.

6. The device wherein said extending cylindrical shank is at a diametric distal from said ratcheting gear within said ratcheting head comprising: a second horizontal square slot to house said second output square shaft that swivels to a folding position and extending vertically to substantially at right angle for second ratcheting mode, said second horizontal square slot to retain said second output square driver shaft within the confines of said square slot of said cylindrical shank of said rotate-able ratcheting gear being housed within said ratcheting head in the second mode; said second square output shaft further includes a horizontal pivoting hole to accept a horizontal retaining pin to retain said second output square shaft to said extended cylindrical configured shank extended from said ratcheting head; said cylindrical shank further includes a knurled exterior for gripping to either fast forward and or reverse ratchet rotation for hand start installation and or hand speed removal of fasteners for said first and second square output shafts of the first and second ratcheting mode.

7. The device in claim 1 wherein said exterior handle length is secured in said first, second hole positions formed on top of said sub-tubular handle being position by said spring induced detent ball housed within said vertical hole positioned in solid flexible ratcheting arm at a distal end of said ratchet head, said detent ball being positioned in said first, second and or third hole formed on said exterior handle.

8. A ratcheting driver head comprising: an extending lug at a distal end from said ratcheting driver head having a horizontal pivoting hole to attach a swivel yoke at a distal inner end of said solid ratcheting arm; both being secured by a horizontal retention pin on a distal end of said solid handle being attached to said radius lug end and co-centrally located at a distal end of said ratcheting head; said extending lug further includes spherical radiuses formed around said radius end with said spherical holes radially formed at +30 degrees, to 0 degrees horizontal to the axis, and −30 degrees manual adjustments; said solid handle and said slide-able exterior hollowed handle both pivot from a substantially right angle to the X axis of said square drivers shafts; said pivotal yoke further includes said pivotal pin to retain said solid arm onto said pivotal yoke; said pivotal yoke further includes a spring induced detent ball to seat into three radially spaced and equally spaced said spherical holes formed on said radiuses end of said lug from said ratcheting head, as said solid arm is being manually adjusted upwards to said +30 degrees angle, said spring induced detent ball on said yoke on said solid arm seats, and locks said solid arms dimple at said +30 degrees upwards angle, as said solid arm is readjusted back to said central Y axis dimple on said yoke end of said solid arm is thus locked in that position, and when said solid arm is readjusted downwards to said −30 degrees, said detent ball secures said solid arm in said third position from said 120 degrees from said substantial right angle of said axis.

9. The device in claim 8 wherein there are said spherical pockets formed radially around said radius of lug end of said ratcheting head, said pockets are angularly spaced to agree with the degree of angular flex said handle is manually adjusted to, as referenced in claim 9.

10. The device in claim 9 wherein there is a spring induced detent ball to secure said solid arm and said extendable arm from said distal end of said ratcheting head at said +30, 0 and −30 degrees approximately angular flexibility.
